(19) United States
(12) Patent Application Publication
(10) Pub. No.: US 2016/0171791 A1
(43) Pub. Date: Jun. 16, 2016

(54) Method and Apparatus For Remote Diagnostics and Maintenance of Vehicles

(71) Applicants: Juan Cervantes, Bloomington, CA (US); Adrian Hernandez, Fontana, CA (US); Benigno Hernandez, Fontana, CA (US)

(72) Inventors: Juan Cervantes, Bloomington, CA (US); Adrian Hernandez, Fontana, CA (US); Benigno Hernandez, Fontana, CA (US)

(21) Appl. No.: 15/047,543

(22) Filed: Feb. 18, 2016

(51) Int. Cl. G07C 5/00; H04L 29/08; G07C 5/08

(52) U.S. Cl. CPC G07C 5/008; G07C 5/0808; H04L 67/12

(57) ABSTRACT

Method and apparatus for remotely controlling an electronic control module (ECM) on a vehicle. By first establishing a connection to a wide area network, a control channel to a remote terminal is created on top of the newly created network connection. An ECM maintenance application is controlled from the remote terminal enabling a remote human user to run diagnostics and control a memory included in the ECM.

### BACKGROUND

The modern motor vehicle is a complex system of mechanical components and electrical components. Distinguishing the modern vehicle from its predecessors is the extensive use of electronic systems, including information processing elements included amongst other complex components used to realize a modern motor vehicle. Although many argue that today's vehicles are overly sophisticated and are including processing elements far beyond the type of technology than that which appears to be required, at least at a first impression.

Despite how the use of advanced technology in motor vehicles is perceived, there are some advantages and capabilities that could have only been realized by the application of processing elements. Use of a processing element in a motor vehicle, embodied as an electronic control module (ECM), allows for expedient diagnostics so that any malfunction or, for that matter, some minor deviation from nominal vehicle operation can be detected and reported.

Diagnostics of anomalous operation by interrogating the ECM has dramatically reduced service and maintenance cost. An ECM is now used in most automobiles and heavy duty trucks.

In recent years, industrial vehicles are also being built with an ECM at the heart of all electrical control of the vehicle and rapid diagnostic functions. Most vehicles today, including large heavy duty vehicles such as truck tractors (commonly known as “big rigs”) and specialty service vehicles such as cultivators and construction tools such as earth movers. And the list of the types of vehicles that use an ECM to control vehicle operation continues to grow and any enumeration set forth here is not intended to limit the scope of the claims appended hereto.

Many cars, trucks, big rigs and specialty vehicles include a diagnostic port interface based on a controller area network (CAN) standard, commonly referred to as a “CAN Bus”. The CAN Bus standard provides for communication protocol between a controller and subservient modules. CAN Bus allows multiple masters to acquire the bus in order to communicate with various modules in a vehicle. In order to provide for physical uniformity, the automotive industry has devised a physical interface standard called the OBD, or on-board diagnostics interface. As of this writing, a second version an on-board diagnostics interface, called OBD-2, is commonly used.

Multi-master control is also an important capability offered by the CAN Bus. As vehicle systems continue to increase in complexity, a single electronic control module may not be able to provide all of the processing power or all of the interfaces that tomorrow's vehicle designers would covet. Accordingly, the generic term of “electronic control module” is now being displaced by other terms including, but not limited to an “engine control unit” or “transmission control unit”.

As one can imagine, every major element in a modern vehicle could also include an electronic control unit (e.g. windshield wipers, transmission, and air conditioning). All of these subsystems could be controlled by one or more master processing elements or these subsystems may need to use the ODB in order to obtain parametric data from another subsystem. As one example, which is not intended to limit the scope of the claims appended hereto, an engine control unit may need to discover the health of a transmission by interacting as a master with a transmission control unit.

Diagnostic information can easily be acquired thanks to the automobile industry's adoption of standard protocols and physical interfaces. Now, even a basic vehicle owner can purchase, at a retail level, a diagnostic scanner that can retrieve error codes from one or more subsystems using the on-board diagnostics bus. And, many of these retail diagnostic scanners also allow a user to adjust internal parameters and/or clear various error indicators in the vehicle's systems and subsystems.

Recognizing that not everyone that owns a motor vehicle is racing to become a certified technician, some diagnostics systems are now available in order to provide a remote diagnostics capability. For example, the HUM system (see www.HUM.com) is a system that uses an ODB-2 module that connects with an application on a smart phone. The ODB-2 module uses Bluetooth technology to communicate with the smart phone that is executing the HUM application. The HUM application can interrogate various subsystems in the vehicle and display these data as diagnostic results.

The HUM application is targeted at bringing customers to a local mechanic. Not only can HUM.com charge vehicle owners for the “privilege” of using HUM, HUM can also charge local mechanics an advertising fee because HUM would direct a vehicle owner to a mechanic based on interpretation of near real-time diagnostics information and other on-board parameters. Using the ODB-2 module connected to the smart phone by Bluetooth, the smart phone application gathers diagnostics and parametric information from various subsystems in the vehicle and identifies required and suggested maintenance and also provides information about service technicians nearby.

It may be all well and good that HUM, and other remote diagnostics systems can retrieve diagnostic data, but there is no means by which to maintain the vehicle when the diagnostic and parametric information gathered remotely is indicative that such maintenance is required. Again, all focus antecedent to this disclosure has been that of directing vehicle owners to a service provider. The service provider can then confirm the results of remote diagnostics and apply any maintenance that is required.

One major problem that faces the operators of industrial or commercial vehicles is that the diagnostic and maintenance functionality required to service a vehicle may be so specialized that there are no local service providers that have access to certain specialized diagnostic and maintenance tools, typically embodied in a general purpose computer that has been augmented with a CAN Bus or ODB-2 interface. The actual operation of such specialized diagnostic and maintenance tools is realized by running a specialized application that enables query and control of a specialized ECM. As such, when a vehicle is disabled because of some parametric indication or error flag raised by one or more subsystems in the vehicle, the vehicle could be hundreds of miles from the special equipment necessary to place the vehicle, at least temporarily, back in service so that more extensive service can be had a later time. Today, the only service option is to tow a disabled vehicle to a special service shop.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for controlling an electronic control module (ECM) on a vehicle:

FIG. 2 is a flow diagram that depicts one example alternative method for establishing a control channel with a remote terminal;

FIG. 3 is a flow diagram that depicts typical commands that are directed to an ECM in response to a control message received by way of the control channel;

FIG. 4 is a flow diagram that depicts alternative methods for remotely retrieving diagnostics information from an ECM;

FIG. 5 is a flow diagram that depicts several alternative methods for retrieving a status indicator from an ECM;

FIG. 6 is a flow diagram that depicts one alternative method that enables a centralized vehicle diagnostics system to detect the location of a vehicle;

FIG. 7 is a pictorial illustration of a system for performing remote diagnostics and sending commands to an electronic control module;

FIG. 8 is a block diagram of one example embodiment of an on-board diagnostics bridge;

FIG. 9 is a data flow diagram that depicts how various functional modules interact with each other as they are executed by a processor and contribute to the operation of an on-board diagnostics bridge; and

FIG. 10 is a pictorial representation of a system and an on-board diagnostics bridge that is based on off-the-shelf components.

### DETAILED DESCRIPTION

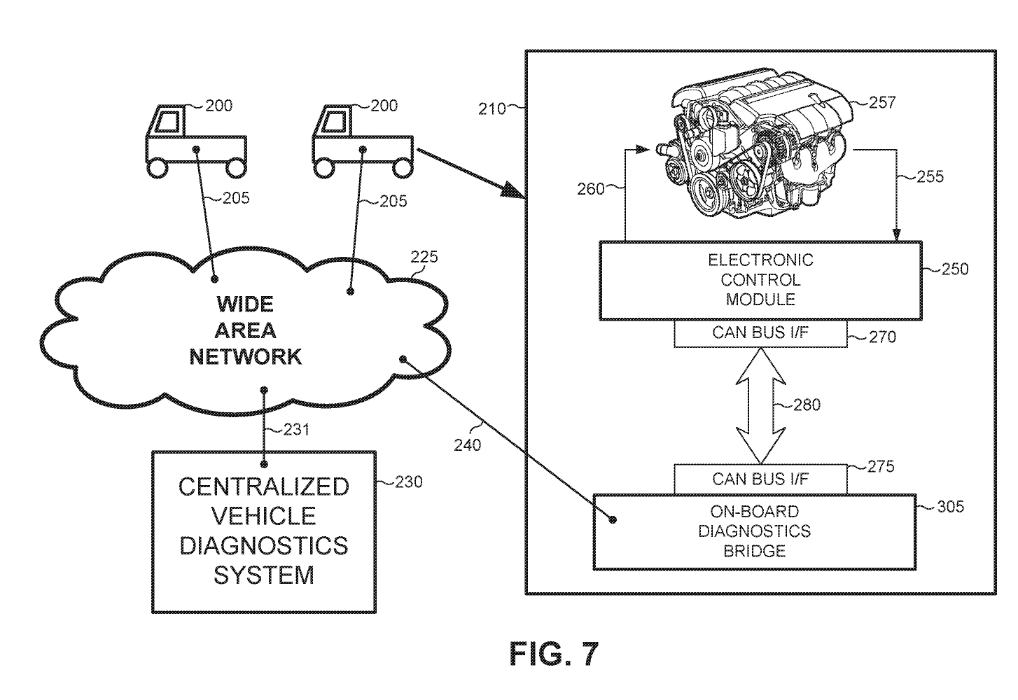

FIG. 7 is a system level interconnection diagram for a remote diagnostics and maintenance system. As can be seen in FIG. 7, a vehicle 200 includes a collection of on-board components 210. FIG. 7 also illustrates that an on-board diagnostics bridge 305, included amongst these on-board components, includes a control area network (CAN) bus interface 275. In a typical application, the can bus interface 275 is electrically connected to an electronic control module 250 by way of a bus 280. It should be appreciated that the ECM 250 also includes a CAN bus interface 270 that is electrically connected to the bus 280, thus providing a bi-directional communication path between the on-board diagnostics bridge 305 and the ECM 250.

In the system context depicted in FIG. 7, a centralized vehicle diagnostic system 230 serves as a remote terminal for interacting with the on-board diagnostics bridge 305. It should also be appreciated that the on-board diagnostics bridge 305 typically comprises a computer that includes a wide area network interface 240 and a CAN Bus interface 275 as heretofore described. Although FIG. 7 refers to an electronic control module, modern vehicles include many subsystem control units, for example an “engine control unit”. The term ECM, as far as this disclosure is concerned, is used to refer not only to a generic ECM, but also to any electronic control unit that is included in the vehicle 200.

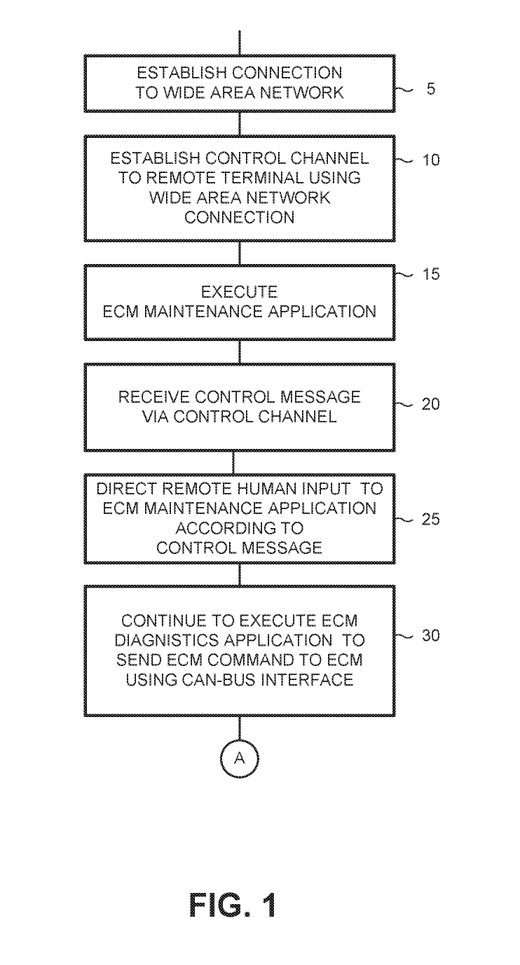

FIG. 1 is a flow diagram that depicts one example method for controlling an electronic control module (ECM) on a vehicle. This example method is best described in context of the remote diagnostics system as depicted in FIG. 7 and described briefly above. In this example method, a connection is established with a wide area network (step 5). Establishing a connection with a wide area network, according to various alternative methods, is accomplished in accordance with well-known techniques and protocols. For example, in one alternative example method, a wide area network connection is established using a Transmission Control Protocol/Internet Protocol (TCP/IP). Any such connection may or may not be a secured connection commensurate with well-known techniques and method used in computer network communications.

There are many well-known techniques for allowing a first user in a first location to relinquish control of a computer, that that user is using, to a second user using a computer in a second location. These systems are typically referred to as remote computer control systems (RCCS). A typical RCCS includes two elements; a first element which operates as a slave element and second element that operates as a master element. The user operating the second, or “master” element is typically able to control any aspect of operation of the computer that relinquished control to the remote computer. It should also be appreciated that the remote computer is often referred to as a remote terminal. As such, the application of any particular remote computer control system, as described by various illustrative use cases here, is not intended to limit the scope of the claims appended hereto.

In this example method, the on-board diagnostics bridge 305 includes a processor that is executing an operating system. Typically, but not necessarily, the operating system executed by the on-board diagnostic bridge 305 is either compatible with, or may comprise a close family member of an operating system that is executed by a processor in a centralized vehicle control system 230.

In one example embodiment of a remote diagnostics system, an ECM maintenance application for interacting with the ECM is received from a vehicle manufacturer. Typically and almost always, the only information that is available for such a software application is a user manual that instructs a technician how to use the software to interrogate the ECM and perform maintenance functions. Given that vehicle manufacturers are reluctant to share details of how the ECM maintenance application actually interacts with the ECM at the level of message flow on the CAN Bus, executing the ECM maintenance application in the on-board diagnostics bridge 305 is the most accurate and cost effective means to control the ECM from a remote terminal.

As already described, the cost associated with understanding the flow of information between an on-board diagnostics bridge 305 and an ECM 250, as effected by a vehicle manufacturer's ECM maintenance application, can be overwhelming. As such, one illustrative example of the present method provides for executing an ECM maintenance application (step 15), as received from the vehicle manufacturer and not modified in any manner, in the on-board diagnostics bridge 305. It should also be appreciated that such a vehicle manufacturer provided application is generally intended to operate with human interaction.

Once the control channel is established, a local computer is able to receive a control message by the control channel (step 15). From the system perspective of FIG. 7, a control message is received by way of the remote control channel (step 15) and such control message is used as at least one basis for directing a command to an ECM. In this example method, this is accomplished by directing a human input, which is represented by the control message, to an instance of the ECM maintenance application (step 25) that is executing in an on-board diagnostics bridge 305. From the perspective of the ECM maintenance application, this human input appears to be from a local user interacting directly with the on-board diagnostic bridge 305. However, according to this example method, a remote operator using a master element of a remote computer control system is the source of human input imparted to the ECM maintenance application that is executing in the on-board diagnostics bridge 305.

In this example method, the ECM maintenance application is allowed to execute so that a human input, received from the remote terminal, results in sending a command (step 27) to the ECM. The ECM maintenance application sends the command to the ECM by way of the CAN bus interface, just as if it would have had received a human input from a local user interacting with the on-board diagnostic bridge 305.

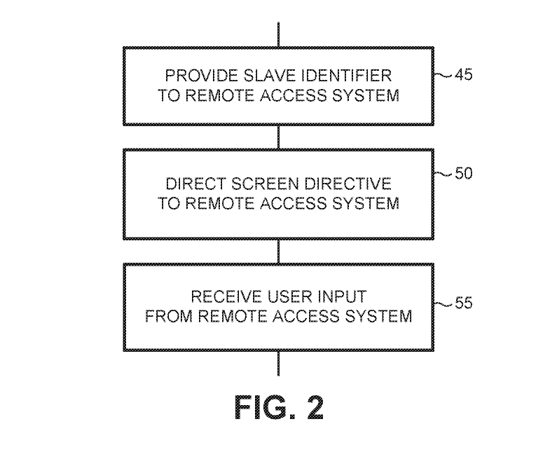

FIG. 2 is a flow diagram that depicts one example alternative method for establishing a control channel with a remote terminal. It should be appreciated that, as a result of numerous pairings of master elements and slave elements in an RCCS, establishing a connection with a remote terminal includes a step wherein a particular slave element identifies itself in order to form a pairing (step 45).

When a remote computer control system slave element, operating in the on-board diagnostics bridge 305, detects that a screen directive has been received by the operating system, the remote computer control system slave element directs the screen directive to a remote computer control master element (step 50). When a screen directive is received by a master element operating in the centralized vehicle diagnostics system 230, the master element directs the screen directive to an operating system operating in the remote terminal.

In one example alternative method, which is not intended to limit the scope of the claims appended hereto, the master element creates a display window on a display screen included in the centralized vehicle diagnostics system 230. The display window represents a display according to the one or more screen directive received from a slave element of an RCCS. It should be understood that the master element directs a screen directive to an operating system executing in the centralized vehicle diagnostics system which is depicted as 230 in FIG. 7.

The operating system executing in the centralized vehicle diagnostics system 230 uses its own hardware drivers to paint an image in the display window, created for representing the display of the screen presented by an operating system executing in the on-board diagnostics bridge. In one example alternative method, a screen directive is associated with a slave identifier to form a screen directive couplet, which is directed to the master element by way of the control channel.

It should be appreciated that, even though the on-board diagnostic bridge 305 may not have a display attached thereto, the on-board diagnostic bridge is still executing an application (e.g. the ECM maintenance application) that typically expects interaction with a human user. Hence, the ECM maintenance application is typically directing at least one of a paint command or a screen directive to the local operating system executing in the on-board diagnostics bridge 305 in order to present information to a local user, which may or may not exists.

A remote user will likely direct a human input to the centralized vehicle diagnostics system in response to information presented on the remote terminal thereof (e.g. in a window created by the master element of the remote computer control system as described supra). The RCCS master element operating in the centralized vehicle diagnostics system 230 will direct indication of such human stimulus to the slave element executing in the on-board diagnostics bridge. This, according to one alternative example method, occurs by associating the user input with a slave identifier to form a “user input couplet”, which is then directed to the slave element using the control channel.

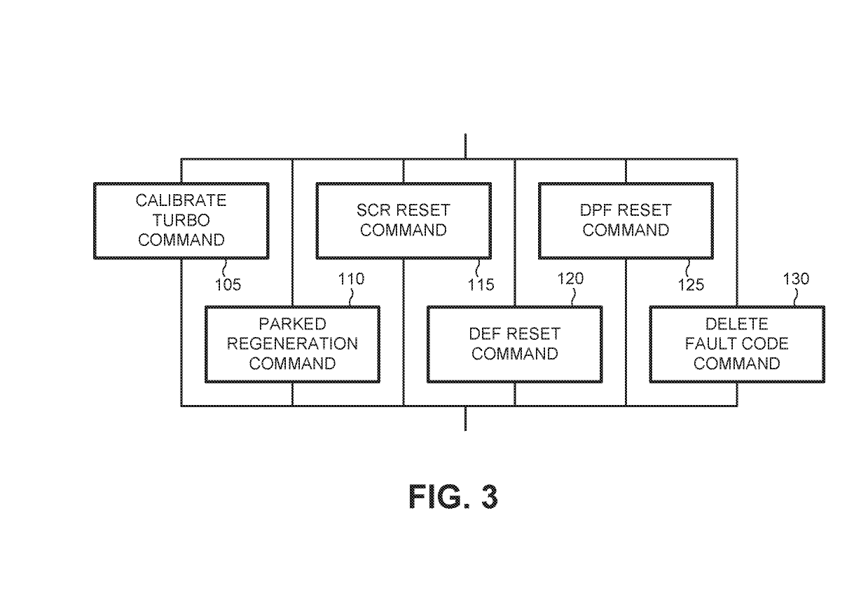

FIG. 3 is a flow diagram that depicts typical commands that are directed to an ECM in response to a control message received by way of the control channel. According to one alternative method, a control message received by way of a control channel results in selecting an ECM command for “calibrating a turbo-charger” (step 105). It should be appreciated that such a control message, in some alternative methods, comprises additional information such as parameters necessary for the turbo-calibration function in an ECM.

In yet another alternative method, a control message received by way of the control channel comprises selecting an ECM command known as a “parked regeneration” command (step 110). This command is common in diesel engine vehicles and is used to initiate a process to clean out a diesel particulate filter (DPM) (i.e. regenerate it) while the vehicle is parked with the engine running.

In yet another alternative method, a control message received by way of the control channel comprises selecting an ECM command known as a “SCR Reset” command (step 115). This command is used to reset a flag in the ECM that is associated with a sensor included in a selective catalytic reduction (SCR) system. Typically, this error code is associated with a disabling event and the vehicle cannot be driven until this error code is cleared (i.e. “reset”).

In yet another alternative method, a control message received by way of the control channel comprises selecting an ECM command known as a “DEF Reset” command (step 120). DEF is an acronym for “diesel exhaust fluid”. DEF is a consumable that is used in emission control. When availability of DEF is in question, a vehicle ECM typically sets a DEF error flag. This command is used to reset a DEF flag. Typically, the DEF error code is associated with a disabling event and the vehicle cannot be driven until this error code is cleared (i.e. “reset”).

In yet another alternative method, a control message received by way of the control channel comprises selecting an ECM command known as a “DPF Reset” command (step 125). DPF is an acronym for “diesel particulate filter”. When the filter used to control diesel particulate matter is spent, a vehicle ECM typically sets a DPF error flag internal to the ECM. This command is used to reset a DPF flag. Typically, the DPF error code is associated with a disabling event and the vehicle cannot be driven until this error code is cleared (i.e. “reset”).

In yet another alternative method, a control message received by way of the control channel comprises selecting an ECM command known as a “Delete Fault Code” command (step 130). As can be imagined, a modern vehicle has many components, many of which are monitored by the ECM. In some cases, there may be fault codes that are entirely innocuous, but persist as annoying indicators to a driver at the wheel of the vehicle. This command is used to clear miscellaneous fault codes.

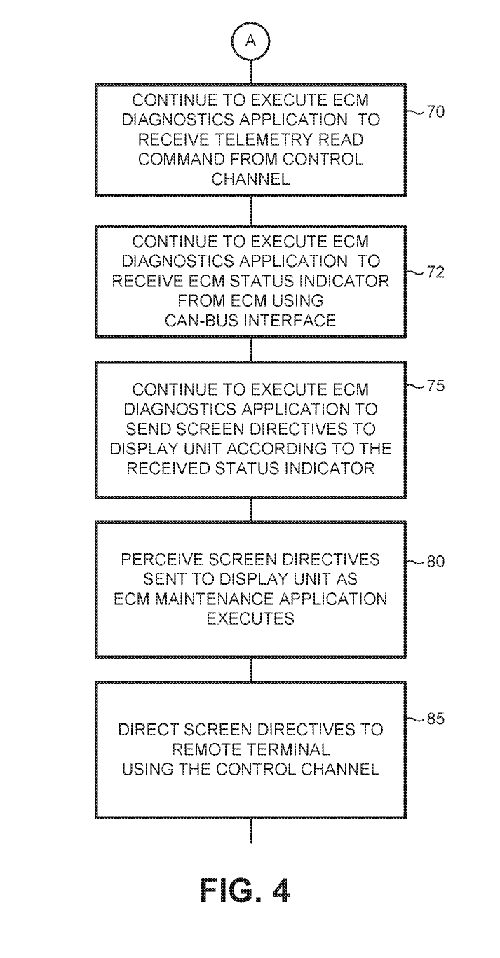

FIG. 4 is a flow diagram that depicts alternative methods for remotely retrieving diagnostics information from an ECM. It should be appreciated that, according to this example alternative method, it is often necessary to retrieve at least one of diagnostic information and a parametric value from the ECM. The term “telemetry”, as used herein, refers to either a diagnostic indicator or to a parameter retrieved from the engine. Given that the special equipment used for such activities may not be locally available, it becomes necessary, in accord with this teaching, to execute an ECM diagnostic application in a diagnostic bridge device included in the vehicle.

As the ECM diagnostic application continues to operate, it will send at least one screen directive to a local operating system executing in an on-board diagnostic bridge in order to prompt a user to select one of one or more telemetry read commands. This, according to at least one alternative method comprises at least one of a particular diagnostic read command and parameter retrieval command.

It should be noted that because the ECM diagnostic application, as provided by the vehicle manufacturer, expects interaction with a local user, it will generate at least one command prompt for presentation to a user whether that user is local or at a remote terminal. According to the teachings of the present example and alternative illustrative methods, a remote user is required to respond to such prompts and such human input is recognized as a request for particular diagnostic information from the ECM. In an alternative method, such a human input is recognized as a request to retrieve a parameter value from the ECM.

In one alternative method, the step of prompting a user is accomplished by allowing the ECM diagnostic application to execute, which will send, to an operating system executing in on-board diagnostic bridge, screen directive that represents one or more telemetry request commands. In response, the operating system will control a local screen memory in order to display the telemetry selection to a user. As already described, such information is presented to a remote user by perceiving screen directive received by the operating system and then directing the screen directive to an RCCS master element executing in a remote computer (i.e. the remote terminal).

When a telemetry selection command is received by the RCCS's slave element operating in the on-board bridge, the slave element then directs a user input to the operating system. This is then forwarded by the operating system to the ECM diagnostic application. The ECM diagnostic application, in turn, will direct one or more commands to the ECM in order to retrieve telemetry in the form of at least one of a diagnostic indicator or a parameter value indicator. Once the ECM diagnostic application has retrieved telemetry from the ECM, it directs display directives to its local operating system in order to present the telemetry to a user.

Based on one or more screen directives, the local operating system will paint information into a display memory, which is located in an on-board diagnostics bridge 305. An RCCS slave element will perceive these screen directives (step 80), as received by the operating system, and forward these directives to an RCCS master element operating in the remote terminal (step 85). In one alternative method, a screen directive is perceived by the local slave element of the RCCS, which will associate the screen directive with a slave identifier to form a screen directive couplet. The screen directive couplet is then directed to the remote terminal by way of the control channel. The master element operating there will use the slave identifier to properly recognize which slave element was the source of the screen directive couplet.

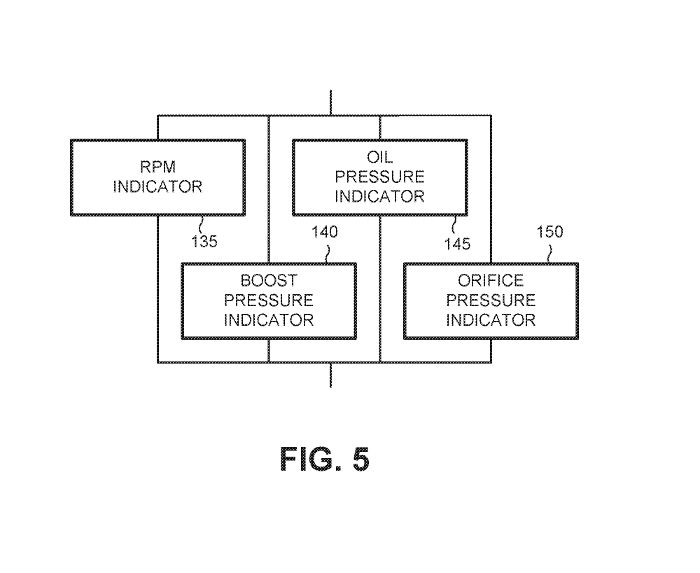

FIG. 5 is a flow diagram that depicts several alternative methods for retrieving a status indicator from an ECM. According to one alternative example method, an on-board diagnostics bridge retrieves a status indicator from the ECM in the form of an revolutions per minute (RPM) indicator (step 135). This form of a status indicator is used for many different diagnostic functions where the rotational speed of an engine is used to factor other parameters.

According to yet another alternative example method, an on-board diagnostics bridge retrieves a status indicator from the ECM in the form of a boost pressure indicator (step 140). A boost pressure indicator provides telemetry from an engine that represents the pressure generated by a turbo charger.

According to yet another alternative example method, an on-board diagnostics bridge retrieves a status indicator from the ECM in the form of an oil pressure indicator (step 145). Such an oil pressure indicator is also useful telemetry from an engine that represents the pressure under which oil is delivered for lubricating an engine.

According to yet another alternative example method, an on-board diagnostics bridge retrieves a status indicator from the ECM in the form of an orifice pressure indicator (step 145). Such an orifice pressure indicator is also useful telemetry from an engine and is useful, according to one alternative method, for calculating the flow through a diesel particulate filter.

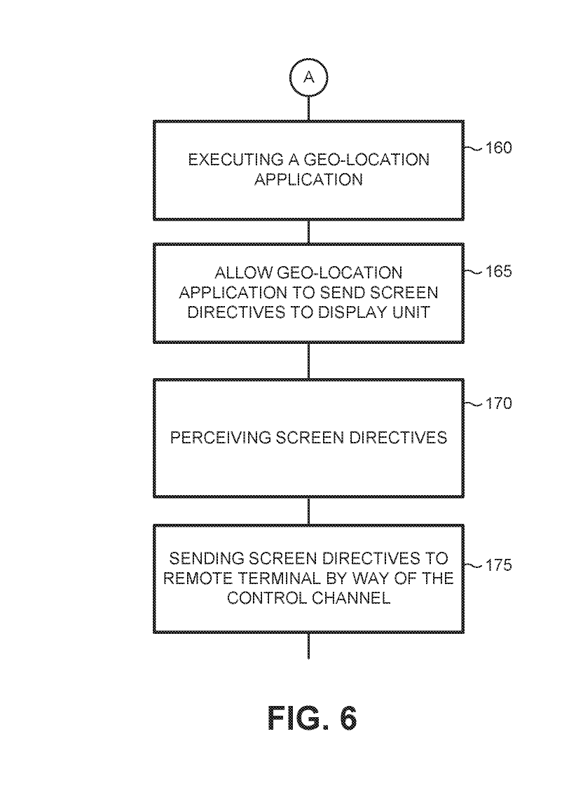

FIG. 6 is a flow diagram that depicts one alternative method that enables a centralized vehicle diagnostics system to detect the location of a vehicle. This alternative method applies the teaching of remote control of the on-board diagnostics bridge 305. Accordingly, a geo-location application is executed (step 160) in the on-board diagnostics bridge 305. As the geo-location application executes, it receives at least one of latitude and longitude from a geo-satellite receiver included in the on-board diagnostics bridge 305.

In accord with the techniques already taught herein, the geo-location application executing in the on-board diagnostics bridge 305 sends screen directives (step 165) to its operating system. These screen directives represent values for latitude and longitude as received by the geo-location application from the geo-satellite receiver. The slave element of an RCCS perceives these screen directives (step 170) and, using the control channel, sends these directives to a master element of the RCCS (step 175) executing in the remote terminal.

FIG. 7 is a pictorial illustration of a system for performing remote diagnostics and sending commands to an electronic control module. According to one embodiment, a system for performing remote diagnostics and sending commands to an ECM comprises a centralized vehicle diagnostics system 230. The centralized vehicle diagnostics system 230 is communicatively coupled to a wide area network 225. The system for performing remote diagnostics and sending commands to an ECM further comprises an on-board diagnostics bridge 305. Typically, the on-board diagnostics bridge 305 is situated in a vehicle 200) and is associated with a collection of components 210. These components include at least on of an electrical component, an electronic component, a mechanical component and an electromechanical component. It should be appreciated that the on-board diagnostic bridge 305 is also communicatively coupled to the wide area network 225.

It should be appreciated that the wide area network 225 may or may not be a private network. One example of a non-private network comprises the Internet. Where a non-private network is used to support the system described in FIG. 7, information is typically exchanged using an encrypted protocol, as well known in the current art of network communications.

It is also important to note that the connection 231 from the centralized vehicle diagnostics system 230 to the wide area network need not be maintained on a continuous basis. Accordingly, this connection 231, according to various alternative embodiment, comprises at least one of a continuous connection and a non-continuous connection. In one alternative example system, the connection 240 from the on-board diagnostics bridge 305 comprises at least one of a continuous connection and a non-continuous connection.

As further depicted in FIG. 7, an electronic control module 250 is communicatively coupled to the on-board diagnostics bridge 305. According to various illustrative use cases, the ECM 250 is communicatively coupled to an engine 257 and provides some form of stimulus and control 260 thereto. And in other illustrative use cases, the engine includes various sensors that are communicatively coupled to the ECM 250.

As already described, the ECM 250 includes a CAN Bus interface 270 as does the on-board diagnostics bridge 305. Bidirectional communication is enabled by a bus 280 that electrically connects the CAN Bus interface 270 included in the ECM 250 to the CAN Bus interface 275 included in the on-board diagnostics bridge 305.

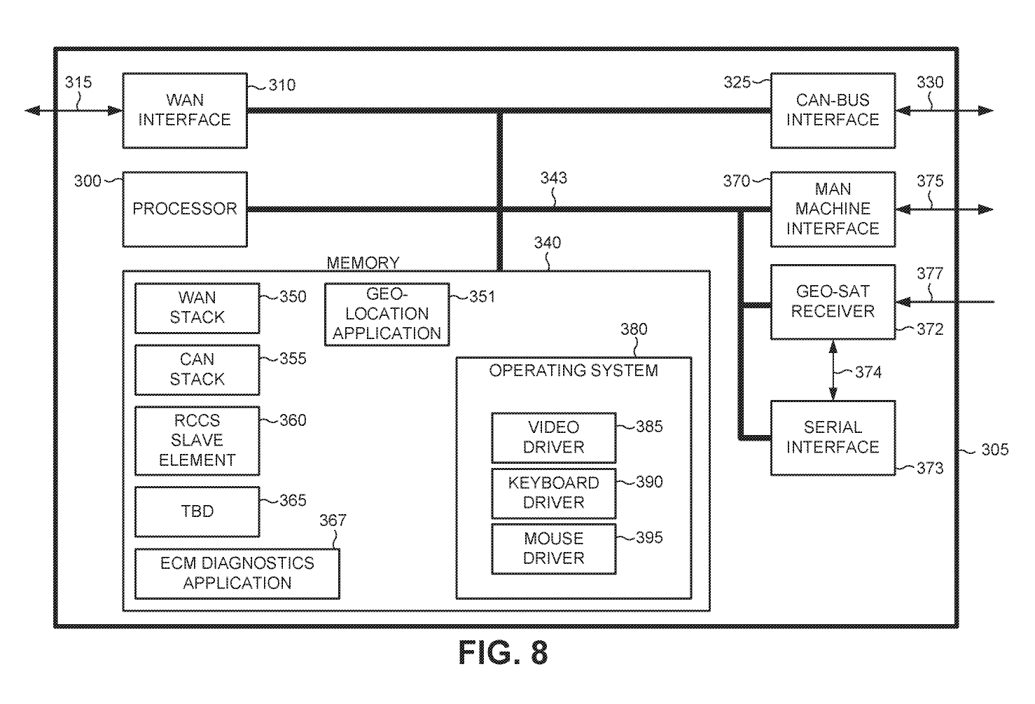

FIG. 8 is a block diagram of one example embodiment of an on-board diagnostics bridge. According to one example embodiment, the on-board diagnostics bridge 305 includes one or more processors 300, a wide area network interface 310, and a CAN Bus interface 325. This first example embodiment also includes a memory 340 that is used to store datum and one or more instruction sequences. The hardware elements included in this first example embodiment are communicatively coupled to each other by means of a bus 343.

One alternative example embodiment of an on-board diagnostics bridge 305 further comprises a geo-satellite receiver 372. In those embodiments that embodiments that include a geo-satellite receiver 372, the geo-satellite receiver 372 is communicatively coupled to the processor 300 by means of a bus 343. There are other alternative embodiments that further comprise a serial interface 373 that is connected to the bus 343 and, in those embodiments, the geo-satellite receiver 372 is communicatively coupled 374 to the serial interface 373. Accordingly, in those alternative embodiments, the processor 300 communicates with the geo-satellite receiver 373 by way of the serial interface 373.

In yet another example embodiment, the on-board diagnostics bridge 305 further comprises a man-machine interface 370. In various alternative embodiments, the man-machine interface includes at least one of a video display unit, a keyboard interface and a cursor control interface.

It should be appreciated that, according to one alternative embodiment, an operating system 380 further includes a video hardware driver 385. In those embodiments where a video driver is included in the operating system 380, the operating system 380, as it is executed by the processor 300, minimally causes the processor 300 to paint information into a display memory. This display memory is included in the man-machine interface 370. In one alternative embodiment, the operating system includes a “null video driver”. The null video driver, when executed by the processor, minimally causes the operating system to ignore screen directives received from an application when the processor 300 executes the null video driver in conjunction with the operating system 380.

Further included in this example embodiment are various functional modules, each of which comprises an instruction sequence. For purposes of this disclosure, a functional module and its corresponding instruction sequence is referred to by a process name, a function name or a module name, each of which may be used interchangeably. The instruction sequence that implements a particular named process, according to one alternative embodiment, is stored in the memory 340.

The reader is advised that the term “minimally causes the processor” and variants thereof is intended to serve as an open-ended enumeration of functions performed by the processor 300 as it executes a particular functional process (i.e. instruction sequence). As such, an embodiment where a particular functional process causes the processor to perform functions in addition to those defined in the appended claims is to be included in the scope of the claims appended hereto.

This first example embodiment further comprises functional modules stored in the memory 340 including a wide area network (WAN) protocol stack 350, a controller area network (CAN) protocol stack 355, an operating system 380, a remote computer control slave element 360, and an ECM diagnostics application 367. In at least one example embodiment, the ECM diagnostics application 367 comprises a software application for a particular type of vehicle and is obtained from or approved by the manufacturer of that vehicle type. Another alternative example embodiment further includes a geo-location application 351, which is also stored in the memory 340.

It should also be evident from this disclosure that any particular protocol stack, according to alternative embodiments, is included in the operating system 380. This disclosure has segregated the WAN protocol stack 350 and the CAN protocol stack 355 from the operating system 380 in order to facilitate description of just how the processor communicates with either the WAN or the CAN Bus when the these protocol stacks are executed by the processor 300. Hence, any embodiment where one or more of the protocol stacks is include in the operating system 380 is intended to fall within the scope of the appended claims.

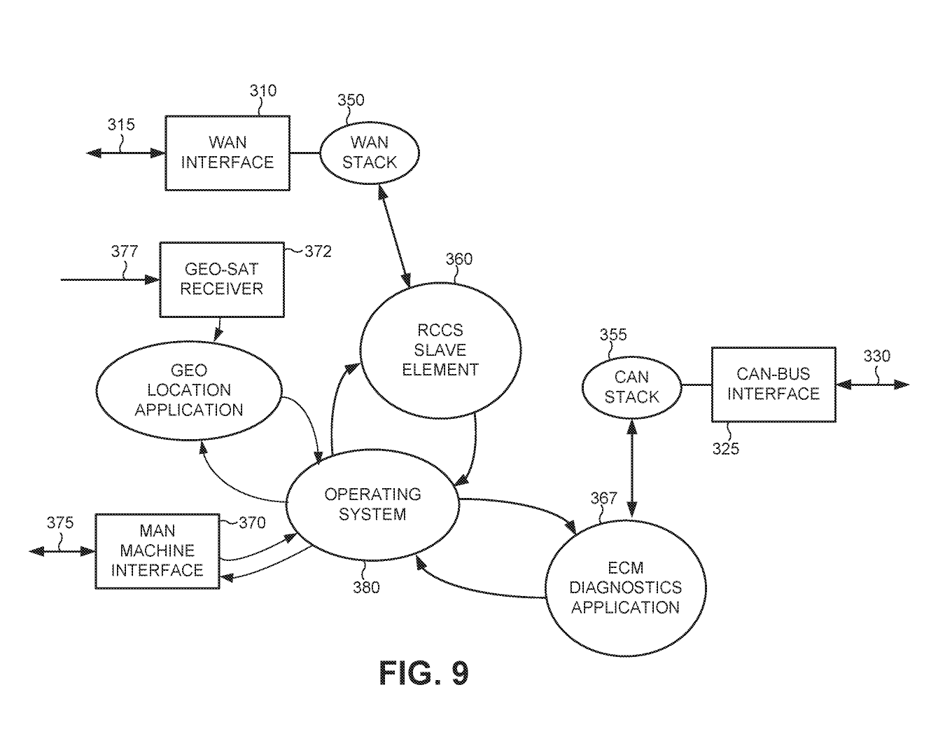

FIG. 9 is a data flow diagram that depicts how various functional modules interact with each other as they are executed by a processor and contribute to the operation of an on-board diagnostics bridge. It should also be appreciated that all the intricate details of how functional modules communicate information to other function modules is not pertinent to the disclosure since these details are well understood in the field of software development. So, as a module develops a particular data, that data may be moved in to the memory 340 for intermediate storage from whence a different module may acquire that data. This detail is not pertinent to the teaching of discoveries set forth in this description and as established in the claims attached hereto.

As the processor 300 begins to execute various instruction sequences, the processor 300, upon receiving an indication that data has been received by the WAN interface 310, continues to execute the WAN protocol stack 350 in order to manage the data received by the WAN interface 310 by way of its connection 315 to the a wide area network. As the processor 300 continues to execute the WAN protocol stack 350, it stores the received data packet in the memory 340.

In one alternative embodiment, the RCCS slave element 360, as it is executed by the processor 300, minimally causes the processor 300 to establish a control channel with a remote terminal, which typically established by an RCCS master element that corresponds to the RCCS slave element 360 included in the on-board diagnostics bridge 305. To do this, the processor 300, as it executes the RCCS slave element 360, is minimally caused to create a connection to a remote terminal using connection protocols embodied in the WAN protocol stack 350. As heretofore stated, the low-level mechanics for receiving a data packet from and sending a data packet to the wide area network is accomplished as the processor 300 executes the WAN protocol stack 350. These mechanics are well known and will not be further described here. It should also be appreciated that, according to one alternative embodiment, the WAN stack comprises a TCP/IP stack.

The RCCS slave element 360 minimally causes the processor 300 to create a control channel using a WAN connection established by the processor 300 as it executes the WAN protocol stack 360. In one alternative embodiment, the RCCS slave element 360, as it is executed by the processor 300, minimally causes the processor 300 to send a slave identifier to the remote terminal using the established WAN connection. This slave identifier facilitates pairing of an RCCS slave element with a corresponding RCCS master element. At this juncture, a remote RCCS master element is able to interact with the RCCS slave element 360 included in the on-board diagnostic bridge 305.

When a command is received from a remote terminal by way of the established control channel, it is subject to a qualification process. This qualification process, according to one alternative embodiment, is accomplished when the processor 300, with continued execution of the RCCS slave element 360, extracts a command message from a data packet received by the processor 300 as it executes the WAN protocol stack 350. Upon successful qualification, which in one alternative embodiment is accomplished by comparing a slave identifier included in a “human input couplet” to a pre-established slave identifier corresponding to a particular on-board diagnostic bridge 305, the processor 300 then extracts a control directive from the received data packet and directs it to the operating system 380.

It should be appreciated that a control directive typically comprises a human input message that represents a human input received by a remote terminal. As such, the RCCS slave element 380 will create a human input message for delivery to the operating system 380. The specific mechanism for delivering such human inputs to the operating system is quite well known and embodied in various remote computer control systems (a.k.a. remote desktop products) such as “GO TO MY PC”, “TEAM VIEWER” and “LOG ME IN”. There are, of course, yet other remote computer control products and the claims appended hereto are not to be limited to any particular remote computer control product or its underlying mechanisms for sharing a local screen with a remote user or for receiving human inputs from a remote user.

The processor 300, as it continues to execute the operating system 380, recognizes a command message it receives from the RCCS slave element 360 as a human input, it directs the human input to the ECM diagnostics application 367. In one example embodiment, the human input comprises a mouse click message. This mouse click message also includes screen coordinates so that the ECM diagnostics application 367 knows what displayed command is selected by the remote user. As can be further appreciated, a human input includes at least one of a “mouse click” message, a cursor movement message, and a “key stroke” message.

At this juncture, it is important to understand that, as the processor 300 begins to execute the ECM diagnostics application 367, the ECM diagnostics application will begin sending screen directives to the operating system 380. These initial screen directives typically represent one or more features of an application window created by the application and are intended to be presented on a local display. These directives are directed to a remote terminal by the processor 300) as it continues to execute the RCCS slave element 360.

It should be appreciated that, according to one alternative embodiment, a screen directive is dispatched to a remote terminal through the use of a screen directive couplet. Accordingly, the RCCS slave element of this alternative example embodiment, when executed by the processor 300, associates a screen directive with a slave identifier in order to create the screen directive couplet. This couplet is then sent to the remote terminal by passing the couplet to the WAN stack. The WAN stack, in turn, as it is executed by the processor 300, engages to send the couplet to the remote terminal using the protocol embodied by the WAN stack.

In various alternative embodiments, the RCCS slave element 360 minimally causes the processor 300 to perceive a screen directive as it is received by the operating system 380. This can be accomplished in several ways. For example, one alternative embodiment perceives screen directives by installing a call-back function in the operating system 380. Such a call-back function will allow the operating system 380 to function normally, but also minimally causes the processor 300 to direct a screen directive received by the operating system 380 to the RCCS slave element 360. It should be appreciated that such a call back mechanism is presented as an example and is peculiar to a particular remote computer control mechanism and this example is not intended to limit the scope of the claims appended hereto.

As the processor 300 continues to execute the ECM diagnostics application 367, the ECM diagnostics application 367 further minimally causes the processor 300 to create one or more additional screen directives to represent ECM commands that can be selected by a user. It should be understood that these directives are received by a remote RCCS master element and, as such, are presented to a remote user. Some of these directives, in one alternative embodiment, cause the remote terminal to display one or more command buttons in an application window presented to a remote user. The remote user can then actuate one of the presented command buttons. This is typically done by accepting a mouse click when a particular command button has the focus within the confines of a remote application window presented on a remote display.

It should, however, be appreciated that the RCCS slave element 360, at least according to one alternative embodiment, when executed by the processor 300, will minimally cause the processor to remap a mouse-click or cursor movement command so as to pertain to an application window created in a local man-machine interface 370. It should be further appreciated that, according to one alternative example embodiment, the video driver 385 included in the operating system 380 comprises a null driver. In this case, only the remote display and its coordinate system is pertinent to selection of a particular command.

Given that a human input is thus received from a remote user, the processor 300, as it continues to execute the operating system 380, will direct a direct the human input to the ECM diagnostics application 367. In turn, the ECM diagnostics application 367, as it is executed by the processor 300X), will interpret a particular human input with selection of a command. As a result, the ECM diagnostics application 367 will interact with the CAN Stack 355 in order to send an ECM command to an ECM 250 by way of the CAN Bus interface 325. It should be appreciated that a particular command sent to the ECM will be selected according the user input, which comprises a command selection.

It should be appreciated that, according to various example embodiments, the ECM diagnostics application 367, as it is executed by the processor 300), will select, based on the user input it received by way of the control channel, at least one of a calibrate turbo command, a parked regeneration command, an SCR reset command, a DEF reset command, a DPF reset command and a delete fault code command.

In one alternative example embodiment, the ECM diagnostics application 367, as it is executed by the processor 300), further minimally causes the processor to send one or more screen directives to the RCCS slave element 360 in order to display on the remote terminal one or more telemetry command from which a remote user is able to select a particular telemetry command. As such, a user at the remote terminal will select a particular telemetry command. This is then conveyed to the RCCS slave element 360 as a user input.

The RCCS slave element 360, as it is executed by the processor 300, sends the user input to the operating system 380, which, as it is executed by the processor 300, sends the user input to the ECM diagnostics application 367. As the processor 300 continues to execute the ECM diagnostics application 367, the ECM diagnostics application 367 further minimally causes the processor 300 to execute the CAN Bus stack in order to retrieve telemetry, be it a diagnostic indicator or a parameter, from the ECM by way of the CAN Bus interface 325.

As the ECM diagnostics application 367 continues to operate, the processor is minimally caused to send one or more screen directives to the operating system 380 in order to display a particular telemetry, again be it a diagnostics indicator or a parameter. As the RCCS slave element 360 is further executed by the processor 300, the RCCS slave element perceives these one or more screen directives and send them to the remote terminal using the pre-established control channel. Accordingly, the RCCS slave element 360, according to one alternative embodiment, minimally causes the processor 300 to associate a screen directive with a slave identifier in order to form a screen directive couplet. As the processor 300 continues to execute the RCCS slave element 360, the RCCS slave element 360 further minimally causes the processor 300 to execute the WAN stack 350 so as to send the screen directive couplet out over the WAN by way of the WAN interface 310 according to the WAN protocol embodied in the WAN stack 350.

It should be appreciated that, according to various alternative embodiments, the RCCS slave element 360, as it is executed by the processor 300, further minimally causes the processor to create one or more screen directive for presenting command actuators on the remote terminal for at least one of an RPM indicator, a boost pressure indicator, an oil pressure indicator and an orifice indicator as heretofore described in terms of method and technique.

The functional processes (and their corresponding instruction sequences) described thus far enable remote diagnostics and control of an electronic control module situated in a vehicle in accordance with the techniques, processes and other teachings of the present method. According to one alternative embodiment, these functional processes are imparted onto computer readable medium. Examples of such medium include, but are not limited to, random access memory, read-only memory (ROM), Compact Disk (CD ROM), Digital Versatile Disks (DVD), floppy disks, flash memory, and magnetic tape. This computer readable medium, which alone or in combination can constitute a stand-alone product, can be used to convert a general or special purpose computing platform into an apparatus capable of remote diagnostics and control of an electronic control module situated in a vehicle according to the techniques, processes, methods and teachings presented herein. Accordingly, the claims appended hereto are to include such computer readable medium imparted with such instruction sequences that enable execution of the present method and all of the teachings afore described.

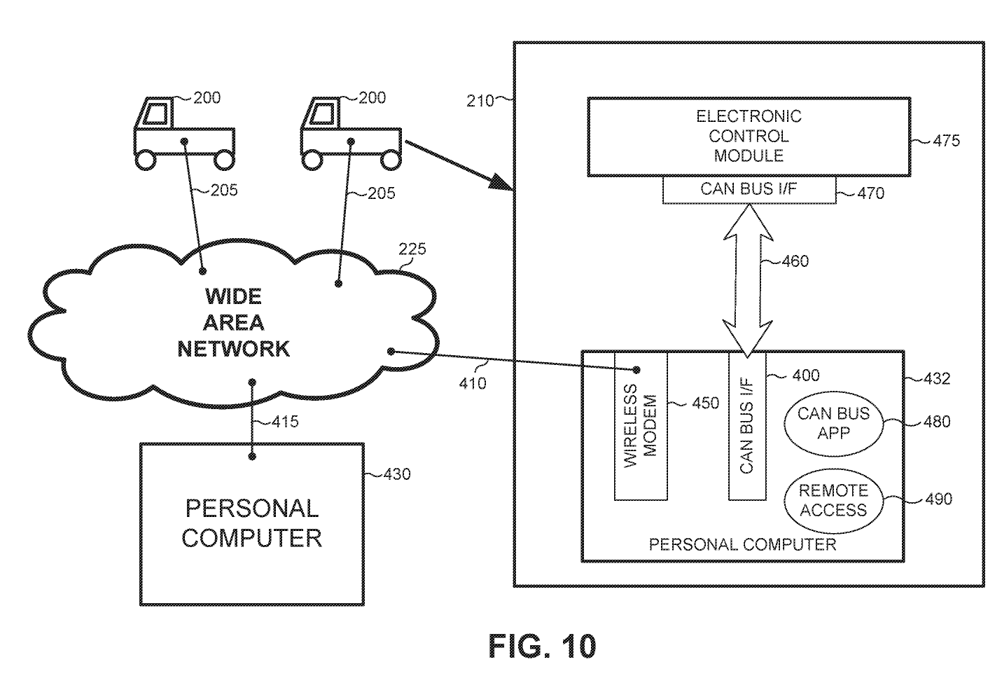

FIG. 10 is a pictorial representation of a system and an on-board diagnostics bridge that is based on off-the-shelf components. In this example embodiment, a simple system for performing remote diagnostics and control of an ECM comprises a processing element 430, which in one alternative embodiment comprises a first personal computer, and a diagnostics bridge 432. In one alternative embodiment, the diagnostics bridge comprises a second personal computer. The diagnostics bridge 432 comprises a processing element, a wireless modem 450 and a CAN Bus interface 400. In a typical embodiment, the CAN Bus interface 400 is installed into an expansion slot in a second personal computer 432.

In this example embodiment, the diagnostics bridge 432 also includes a CAN Bus application 480 that controls the CAN Bus interface 400. This CAN Bus application 480 comprises an off-the-shelf software product that is specific to a particular type of vehicle. Also included in this embodiment is a remote computer access application 490. The remote computer access application 490 allows a user at a remote location to use a personal computer 430 to interact with a graphical desktop that is maintained by the diagnostics bridge 432. In this way, a remote user is able to execute the CAN Bus application in order to conduct diagnostics and effect maintenance on an ECM.

It should be appreciated that the diagnostics bridge 432 may not have a physical display, but the operating environment for the CAN Bus application 480 requires interaction with a human user. Accordingly, the diagnostics bridge 432 includes at least one of a graphical engine controlled by a driver and a null graphics driver. In the case of a graphical engine that is controlled by a driver, the CAN Bus application 480 interacts with an operating system in order to actually create images in a memory included in the graphical engine. In an alternative embodiment, a null graphics driver is used by the operating system when there is no graphics hardware.

In this alternative embodiment, the CAN Bus application 480 interacts with an operating system in order to generate display directives, which are then simply dropped by the null graphics driver.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for controlling an electronic control module (ECM) on a vehicle comprising:
establishing a connection to a wide area network;
establishing a control channel with a remote terminal by way of the wide area network connection;
receiving a control message by way of the control channel; and
executing an ECM maintenance application, said application ordinarily intended to interact with a human user;
directing a remote human input to the ECM maintenance application according to the received control message; and
continuing to execute the ECM diagnostics application in order to send an ECM-command to the electronic control module by way of a controller area network bus, said ECM-command being selected according to the remote human input.

2. The method of claim 1 wherein establishing a control channel to a remote terminal comprises:
providing a slave identifier to a remote computer control system master element;
directing a screen directive to the remote computer control system master element; and
receiving a user input from the remote computer control system master element.

3. The method of claim 1 wherein selecting a command to be sent to the electronic control module comprises at least one of selecting a calibrate turbo command, selecting a parked regeneration command, selecting a SCR reset, selecting a DEF reset, selecting a DPF reset and selecting a delete fault code command.

4. The method of claim 1 further comprising:
continuing to execute the ECM maintenance application in order to receive an ECM-status indicator from the electronic control module by way of a controller area network bus;
allowing the ECM maintenance application to send a screen directive to a user display unit according to the status indicator;
perceiving the screen directive directed to the user display unit as the ECM maintenance application continues to execute; and
according to the screen directive, directing a display message to the remote terminal by way of the control channel.

5. The method of claim 4 wherein receiving an ECM-status indicator from the electronic control module comprises
receiving at least one of an RPM indicator, a boost pressure indicator, an oil pressure indicator, and an orifice pressure indicator.

6. The method of claim 4 further comprising:
executing a geo-location application in order to determine a geo-location, said geo-location application configured to control a satellite positioning system receiver; and
allowing the geo-location application to send a screen directive to a user display unit according to a determined geo-location;
perceiving the screen directive directed to the user display unit as the geo-location application continues to execute; and
directing the screen directive to the remote terminal by way of the control channel.

7. A on-board diagnostics bridge comprising:
processor;
wide area network (WAN) interface;
control area network (CAN) interface;
memory;
functional modules stored in the memory including:
WAN protocol stack that, when executed by the processor, minimally causes the processor to receive a data packet from the wide area network and store said data packet in the memory;
CAN protocol stack that, when execute by the processor, minimally causes the processor to transmit a data packet using the controller area network interface according to information stored in the memory;
operating system module that, when executed by the processor, minimally causes the processor to accept screen directives from an application and create an image in a screen image memory and further minimally causes the processor to accept inputs from a user by way of at least one of a keyboard and a mouse, and direct user input messages to the application;
remote computer control slave element that, when executed by the processor, minimally causes the processor to receive a remote human input message from a remote terminal as it executes the wide area network protocol stack and further minimally directs the remote human input message to the operating system module; and
electronic control module diagnostics application that, when executed by the processor, minimally causes the processor to receive a user input from the operating system module and further minimally causes the processor to direct a command, according to the received user input, to the control area network interface by further minimally causing the processor to execute the control area network interface protocol stack.

8. The on-board diagnostics bridge of claim 7 wherein the WAN stack comprises a Transmission Control Protocol/Internet Protocol stack.

9. The on-board diagnostics bridge of claim 7 wherein the electronic control module diagnostics application causes the processor to direct a command to the control area network by minimally causing the processor to direct to the control area network by executing the CAN protocol stack at least one of a calibrate turbo command, a parked regeneration command, a SCR reset, a DEF reset, a DPF reset and a delete fault code command.

10. The on-board diagnostics bridge of claim 7 wherein the remote computer control slave element causes the processor to receive a remote human input and direct said input to the operating system by minimally causing the processor to:
direct a slave identifier to a remote terminal by causing the processor to execute the WAN stack;
receive an input couplet from the remote terminal by causing the processor to execute the WAN stack;
qualify the input couplet according to the slave identifier; and
direct a human input portion of a qualified couplet to the operating system.

11. The on-board diagnostics bridge of claim 7 wherein the remote computer control slave element further minimally causes the processor to direct a screen directive to the remote terminal by minimally causing the processor to:
receive a screen directive from the operating system;
associate the screen directive with a slave identifier to form a screen couplet; and
direct the screen couplet to a remote terminal by causing the processor to execute the WAN stack.

12. The on-board diagnostics bridge of claim 7 wherein the electronic control module diagnostics application further minimally causes the processor to receive an ECM-status indicator by further minimally causing the processor to:
execute the CAN stack in order to receive an ECM-status indicator from the CAN interface; and
direct a screen directive to the operating system wherein the remote computer control slave element further minimally causes the processor to receive a screen directive from the operating system and further minimally causes the screen directive to be directed to a remote terminal by causing the processor to execute the WAN protocol stack.

13. The on-board diagnostics bridge of claim 7 wherein the electronic control module diagnostics application further minimally causes the processor to receive an ECM-status indicator by further minimally causing the processor to execute the CAN protocol stack in order to receive at least one of an RPM indicator, a boost pressure indicator, an oil pressure indicator, and an orifice pressure indicator.

14. A computer readable medium that is imparted with one or more instruction sequences including:
WAN stack that, when executed by a processor, minimally causes the processor to receive a data packet from a wide area network and store said data packet in a memory;
CAN protocol stack that, when execute by a processor, minimally causes a processor to transmit a data packet using a controller area network interface according to information stored in a memory;
operating system module that, when executed by a processor, minimally causes a processor to accept a screen directive from an application and create an image in a screen image memory and further minimally causes a processor to accept inputs from a user by way of at least one of a keyboard and a mouse, and direct user input messages to the application;
remote computer control slave element that, when executed by a processor, minimally causes a processor to receive a remote human input message from a remote terminal as it executes a wide area network protocol stack and further minimally directs a remote human input message to an operating system module; and
electronic control module diagnostics application that, when executed by a processor, minimally causes a processor to receive a user input from an operating system module and further minimally causes a processor to direct a command, according to a received user input, to a control area network interface by further minimally causing a processor to execute a control area network interface protocol stack.

15. The computer readable medium of claim 14 wherein the WAN stack comprises a Transmission Control Protocol/Internet Protocol stack.

16. The computer readable medium of claim 14 wherein the electronic control module diagnostics application causes a processor to direct a command to a control area network by minimally causing a processor to direct to a control area network by executing a CAN protocol stack at least one of a calibrate turbo command, a parked regeneration command, a SCR reset, a DEF reset, a DPF reset and a delete fault code command.

17. The computer readable medium of claim 7 wherein the remote access module causes a processor to receive a remote human input and direct said input to an operating system by minimally causing a processor to:
direct a slave identifier to a remote terminal by causing a processor to execute a WAN stack;
receive an input couplet from a remote terminal by causing a processor to execute a WAN stack;
qualify an input couplet according to a slave identifier; and
direct a human input portion of a qualified couplet to an operating system.

18. The computer readable medium of claim 14 wherein the electronic control module diagnostics application further minimally causes a processor to receive an ECM-status indicator by further minimally causing a processor to:
execute a CAN stack in order to receive an ECM-status indicator from a CAN interface; and
direct a screen directive to an operating system wherein the remote computer control slave element further minimally causes a processor to receive a screen directive from an operating system and further minimally causes the screen directive to be directed to a remote terminal by causing a processor to execute the WAN protocol stack.

19. The computer readable medium of claim 14 wherein the electronic control module diagnostics application further minimally causes a processor to receive an ECM-status indicator by further minimally causing a processor to execute a CAN protocol stack in order to receive at least one of an RPM indicator, a boost pressure indicator, an oil pressure indicator, and an orifice pressure indicator.

20. A on-board diagnostics bridge for remotely interacting with an electronic control module (ECM) on a vehicle comprising:
means for establishing a connection to a wide area network;
means for establishing a control channel with a remote terminal by way of the wide area network connection;
means for receiving a control message by way of the control channel; and
means for executing an ECM maintenance application, said application ordinarily intended to interact with a human user;
means for directing a remote human input to the ECM maintenance application according to the received control message; and
means for continuing to execute the ECM diagnostics application in order to send an ECM-command to the electronic control module by way of a controller area network bus, said ECM-command being selected according to the remote human input.
